(19) United States
(12) Patent Application Publication
(10) Pub. No.: US 2019/0275953 A1
(43) Pub. Date: Sep. 12, 2019

(54) MOUNTING STRUCTURE

(71) Applicants: Koji Mori, Aichi (JP); Takayuki Suzuki, Aichi (JP); Yuichi Fujii, Aichi (JP); Mamoru Minamide, Aichi (JP); Takuya Eguchi, Aichi (JP)

(72) Inventors: Koji Mori, Aichi (JP); Takayuki Suzuki, Aichi (JP); Yuichi Fujii, Aichi (JP); Mamoru Minamide, Aichi (JP); Takuya Eguchi, Aichi (JP)

(73) Assignee: OMRON AUTOMOTIVE ELECTRONICS CO., LTD., Aichi (JP)

(21) Appl. No.: 16/299,892

(22) Filed: Mar. 12, 2019

(30) Foreign Application Priority Data
Mar. 12, 2018 (JP) 2018-044103

(51) Int. Cl. B60R 11/00; B60R 16/02

(52) U.S. Cl. CPC B60R 11/00; B60R 2011/0075; B60R 16/02

(57) ABSTRACT

A mounting structure is provided which includes: a holding member provided on a mounting surface on a side of a vehicle body; and a held member provided on a casing, at least partially configured of an elastic body, and configured to be held by the holding member. The held member is mounted in a state of pressing the elastic member due to elastic force (indicated by a dotted arrow) of the elastic body.

### CROSS-REFERENCE TO RELATED APPLICATION

This application is based on Japanese Patent Application No. 2018-044103 filed with the Japan Patent Office on Mar. 12, 2018, the entire contents of which are incorporated herein by reference.

### FIELD

The present invention relates to a mounting structure, and particularly relates to a mounting structure for mounting a casing that houses an electronic component on a vehicle body.

### BACKGROUND

Conventionally, there is proposed a mounting structure for mounting a casing which houses an electronic component such as an electronic circuit board or an electrical connector on a vehicle body. For example, JP 2012-206631 A discloses an in-vehicle control device capable of flexibly responding to a design change and suppressing damage to an electronic circuit board. This in-vehicle control device includes a casing which houses the electronic circuit board, and a bracket which is welded and joined to the casing and is mounted on a vehicle. The casing and the bracket are made of resin. The casing and the bracket are welded and joined by laser welding. One of the casing and the bracket is formed of a light-transmitting resin which has a light transmitting property of transmitting laser light used for laser welding. The other is formed of a light-absorbing resin which absorbs laser light.

In addition, JP 10-6883 A discloses a connector mounting structure for mounting a connector on a vehicle in a state where the connector can be displaced with a simple configuration without causing an increase in the number of components. In this mounting structure, a connector of a wire harness to be wired to a rear door of the vehicle is mounted on a weather strip. In the connector, a housing main body is provided with flanges each having a through hole. The weather strip is provided with projections each having a hook provided at a front end of the projection. By pressing the connector against the weather strip while inserting the projections through the through holes and engaging a hook portion of each projection with each flange, the connector is mounted on the weather strip.

### SUMMARY

In a mounting structure for mounting a casing that houses an electronic component such as an electronic circuit board or an electrical connector on a vehicle body, a structure for suppressing rattling and flapping due to vibration and impact occurring during traveling of a vehicle or caused by opening or closing of a door is required. In addition, it is desirable to simplify the necessary structure on a side of the vehicle body on which the casing is mounted as much as possible and to reduce the number of mounting man-hours as much as possible.

The present invention has been made in view of the above circumstances, and an object of the present invention to provide a mounting structure that suppresses rattling and flapping caused by vibration and impact, simplifies the structure on a side of a vehicle body on which a casing is mounted as much as possible, and reduces the number of mounting man-hours.

In order to solve the above-described problems, a mounting structure for mounting a casing that houses an electronic component on a vehicle body is provided. The mounting structure includes: a holding member provided on a mounting surface on a side of the vehicle body; a held member provided on the casing, at least partially configured of an elastic body, and configured to be held by the holding member. The held member is mounted in a state of pressing the mounting surface due to elastic force of the elastic body.

According to this, since the held member is mounted in the state of pressing the mounting surface due to the elastic force of the elastic body, it is possible to suppress rattling and flapping due to vibration and impact. In addition, it is possible to provide a mounting structure in which the structure on the side of the vehicle body on which the casing is mounted is simplified as much as possible and mounting man-hours is reduced.

Further, the held member may include: an abutting portion configured to abut against the mounting surface in a case where the held member is mounted; an abutting and held portion configured to abut against the holding member in a case where the held member is mounted; an extended portion extending between the abutting portion and the abutting and held portion and at least partially made of an elastic body; and a connecting portion connecting the abutting and held portion and the casing. In a case where the held member is mounted, the abutting portion may press the mounting surface and the abutting and held portion may press the holding member in a direction opposite to a direction in which the abutting portion presses the mounting surface.

According to this, the extended portion between the abutting portion and the abutting and held portion has elasticity, the abutting portion presses the mounting surface, and the abutting and held portion presses the holding member in the direction opposite to the direction in which the abutting portion presses the mounting surface. Therefore, it is possible to suppress rattling and flapping due to vibration and impact, to simplify the structure on the side of the vehicle body on which the casing is mounted as much as possible, and to reduce mounting man-hours.

Further, each of the connecting portion and the holding member may have a drain hole preventing liquid stagnation.

According to this, by providing the drain holes in portions where liquid easily accumulates, it is possible to prevent the material of the casing from being hydrolyzed.

Further, the held member may further include guard portions disposed on both sides of the abutting portion and configured to protect the abutting portion.

According to this, by providing the guard portions configured to protect the abutting portion projecting from the casing, it is possible to prevent the extended portion from being destroyed due to handling or the like at the time of mounting.

Further, the mounting surface may include a mounted portion, and the casing may include a mounting portion matching the mounted portion. In a case where the mounting portion is mounted, the mounting portion may be fixed to the mounted portion, and the location where the abutting portion presses the mounting surface may be in the middle between the location where the mounting portion and the mounted portion are fixed and the location where the abutting and held portion presses the holding member.

According to this, since the mounting portion and the mounted portion are fixed, it is possible to suppress rattling and flapping due to vibration and impact. In addition, it is possible to simplify the structure on the side of the vehicle body on which the casing is mounted as much as possible and to reduce the mounting man-hours.

As described above, according to the present invention, it is possible to provide a mounting structure that suppresses rattling and flapping caused by vibration and impact, simplifies the structure on the side of the vehicle body on which the casing is mounted as much as possible, and reduces the number of mounting man-hours.

### BRIEF DESCRIPTION OF THE DRAWINGS

FIG. 1A is a front view and FIG. 1B is a side view of a casing according to a first embodiment of the present invention.

FIG. 2A is a perspective view and FIG. 2B is a cross-sectional perspective view taken along line S-S of FIG. 1A, of the casing according to the first embodiment of the present invention.

FIG. 3A is a perspective view as viewed from above, FIG. 3B is a perspective view as viewed from below, FIG. 3C is an enlarged perspective view of portion D of FIG. 3A, and FIG. 3D is an enlarged perspective view of portion E of FIG. 3B, of a vehicle body mounting member according to the first embodiment of the present invention.

FIG. 4A is a perspective view and FIG. 4B is an enlarged perspective view of portion A of FIG. 4A, FIGS. 4A and 4B illustrating a mounting structure of the first embodiment according to the present invention.

FIG. 5A is a perspective view of the casing as viewed from below, FIG. 5B is an enlarged perspective view of portion B of FIG. 5A, FIG. 5C is a bottom view of the casing, and FIG. 5D is a bottom view of the mounting structure, of the first embodiment according to the present invention.

FIG. 6 is a front view (portions hidden by the vehicle body mounting member of the casing are indicated by dotted lines) as viewed from a side of the vehicle body mounting member in a case where the vehicle body mounting member and the casing are combined, in the first embodiment according to the present invention.

FIG. 7A is a cross-sectional view taken along line C-C of FIG. 6 in a case where the casing is mounted on the vehicle body mounting member and FIG. 7B is a cross-sectional view taken along line C-C of FIG. 6 in the process of mounting the casing on the vehicle body mounting member, FIGS. 7A and 7B illustrating the mounting structure of the first embodiment according to the present invention.

### DETAILED DESCRIPTION

Hereinafter, an embodiment of the present invention will be described below with reference to the drawings.

### First Embodiment

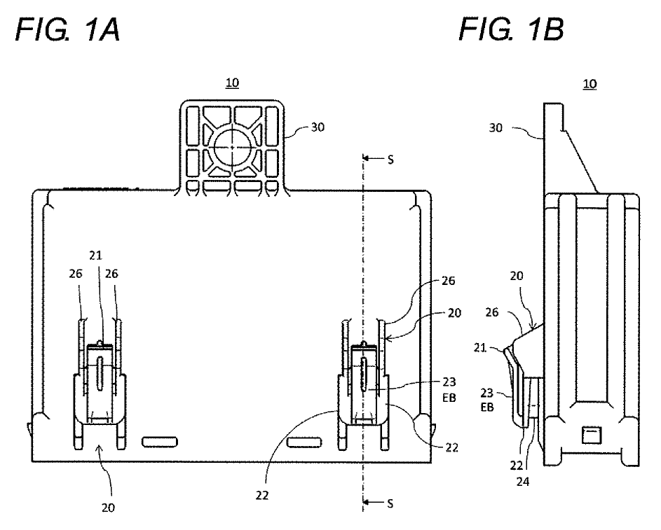

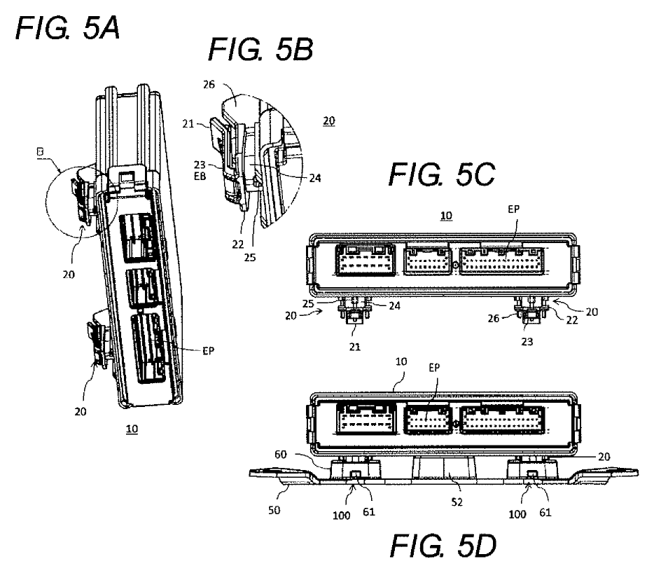

With reference to FIGS. 1A to 7B, a mounting structure 100 according to an embodiment will be described. The mounting structure 100 is a structure for mounting a casing 10 to a vehicle body C. The mounting structure 100 includes a holding member 60 provided on the side of the vehicle body C, and a held member 20 provided on the casing 10 and held by the holding member 60. The casing 10 includes therein an electric circuit board on which an electronic component is mounted, and is formed by injection molding of polyester resin such as PBT (polybutylene terephthalate) resin. Since an electric circuit housed in the casing 10 is used for controlling, for example, locking and unlocking and opening and closing of a vehicular door, opening and closing of a power window, operation of a side mirror, and the like, the casing 10 is provided inside the door or the like. Therefore, the casing 10 receives vibration caused by travelling of the vehicle and impact caused by opening and closing of the door. The mounting structure 100 has a structure of protecting the electric circuit board inside from such vibration and impact and suppressing rattling and flapping.

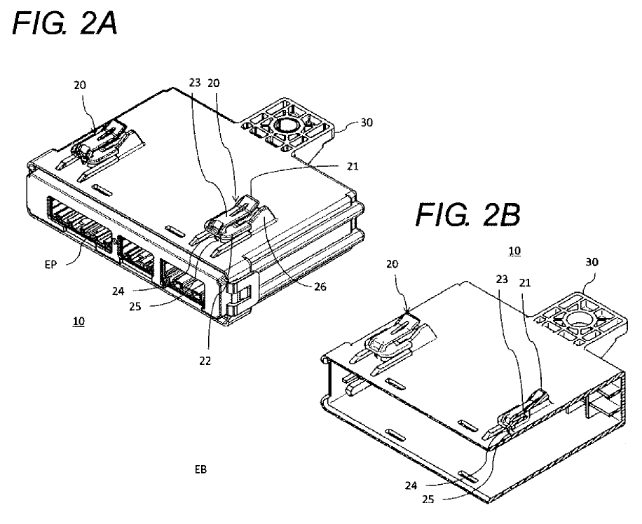

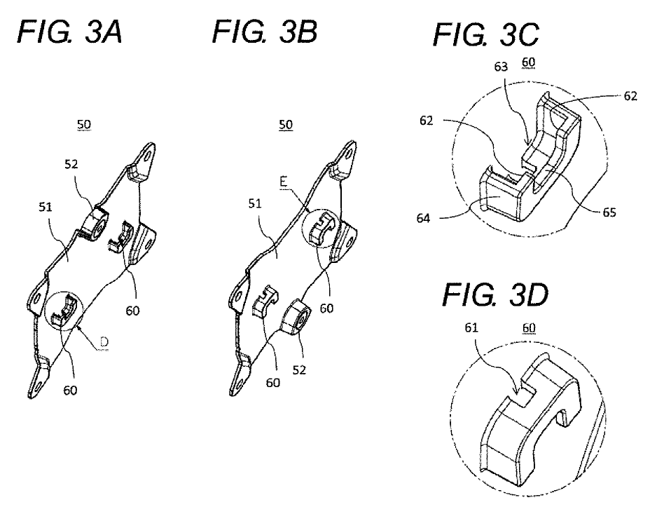

Two held members 20 are provided on the surface of the casing 10 facing the vehicle body C, and are located near side surfaces of the casing 10 (see FIGS. 1A to 2B). Needless to say, the number of held members 20 provided is not limited, and only one held member which is wider than the held member 20 may be provided at the center. Two holding members 60 on the side of the vehicle body C are provided on the surface facing the casing 10 (surface opposite to the surface facing the vehicle body C) of a vehicle body mounting member 50 directly mounted on the vehicle body C. The two holding members 60 are provided at locations matching the held members 20. The vehicle body mounting member 50 has holes for mounting the vehicle body mounting member 50 on the vehicle body C, and the holes are provided at four corners of the vehicle body mounting member 50 (see FIGS. 3A and 3B). The vehicle body mounting member 50 is firmly fastened to the vehicle body C with bolts or the like so as to be mounted on the vehicle body C. Note that the vehicle body mounting member 50 can be mounted on the vehicle body C at any angle whether the vehicle body mounting member 50 is mounted on a vertical surface or a horizontal surface of the vehicle body C. Therefore, the mounting structure 100 can also be mounted at any angle.

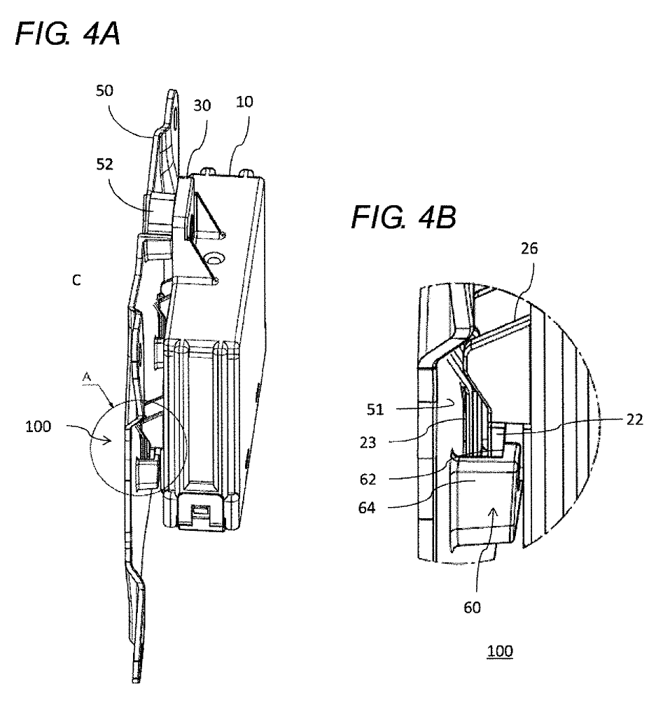

The holding member 60 is provided on a mounting surface 51 of the vehicle body mounting member 50 existing on the side of the vehicle body C as viewed from the casing 10 (see FIGS. 3A, 3B, and 4A). The mounting surface 51 is a flat surface disposed so as to face a front-side surface of the casing 10 in a case where the casing 10 is mounted. The holding member 60 is provided so as to project from the mounting surface 51, and is formed so as to receive the held member 20 inserted in the holding member 60 from above (see FIG. 3C). Specifically, in order to hold the held member 20, the holding member 60 has an insertion recessed portion 63 in which the held member 20 is inserted and which receives the held member 20, insertion guide portions 64 which guide both side surfaces of the held member 20 when the held member 20 is inserted, a support 65 which is one step lower than the insertion guide portion 64 on the side of the casing 10 and supports a connecting portion 24 of the held member 20, which will be described later, in a process of mounting, and an inner portion 62 which abuts against an abutting and held portion 22 of the held member 20, which will be described later, upon mounting.

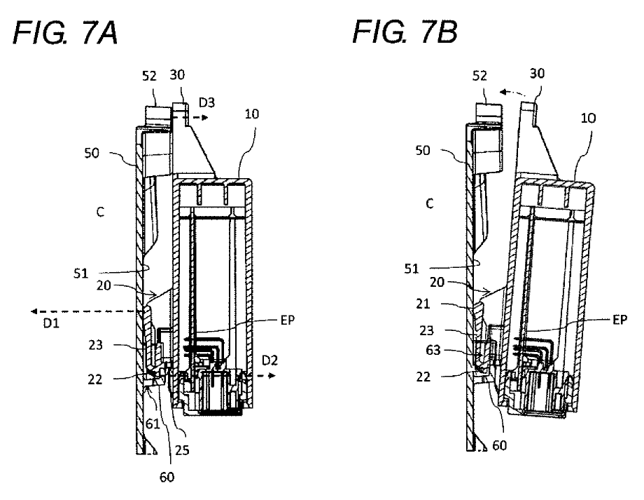

The insertion recessed portion 63 is configured to receive and house a lower portion of the held member 20, and the insertion recessed portion 63 is slightly thicker than the held member 20 and has play (see FIGS. 4B, 7A, and 7B). The support 65 extends from lower portions of the both insertion guide portions 64 on the side of the casing 10 and is formed one step lower than the upper ends of the insertion guide portions 64. When the lower portion of the held member 20 is inserted to the insertion recessed portion 63 of the holding member 60 upon mounting of the casing 10 to the mounting surface 51, the support 65 supports the connecting portion 24 in order to temporarily support the held member 20. The inner portion 62 is positioned at a location facing the mounting surface 51. As will be described later, in the mounting structure 100, the abutting portion 21 presses the mounting surface 51 and the abutting and held portion 22 presses the inner portion 62 due to elastic force, and thus the casing 10 is mounted on the mounting surface 51.

The held member 20 includes: the abutting portion 21 configured to abut against the mounting surface 51 in a case where the held member 20 is mounted; the abutting and held portion 22 configured to abut against the inner portion 62 of the holding member 60 in a case where the held member 20 is mounted; an extended portion 23 extending between the abutting portion 21 and the abutting and held portion 22 and at least partially made of an elastic body EB; and the connecting portion 24 connecting the abutting and held portion 22 and the casing 10 (See FIGS. 1A, 1B, 2A, 2B, 4A, 4B, and 5A to 5D). The connecting portion 24 is erected in a U shape from the front-side surface of the casing 10, and the abutting and held portion 22 is formed in a flange shape at an erected end portion of the connecting portion 24. The U-shaped bottom portion of the connecting portion 24 matches the support 65, and the support 65 is combined so as to be fitted between the front-side surface of the casing 10 and the abutting and held portion 22 having a flange shape (see FIGS. 4A, 4B, 7A, and 7B).

The extended portion 23 is formed such that the extended portion 23 once extends from the lower end portion of the abutting and held portion 22 having the flange shape toward the mounting surface 51 (direction vertical to the front-side surface of the casing 10), and then is curved and extends upward substantially in parallel to the front-side surface of the casing 10. The extended portion 23 further extends toward the mounting surface 51 near the front end of the extended portion 23. The abutting portion 21 is formed at the front end of the extended portion 23 (see FIGS. 1B, 2A, and 2B). The abutting portion 21 is formed so as to linearly abut against the mounting surface 51, that is, to be in linear contact. In the extended portion 23, at least a portion near the curved portion or the entire portion from the connecting portion with the abutting and held portion 22 to the abutting portion 21 is made of elastic resin (elastic body EB). Therefore, when the abutting portion 21 is pushed toward the casing 10, a reaction force against the pushing force is generated.

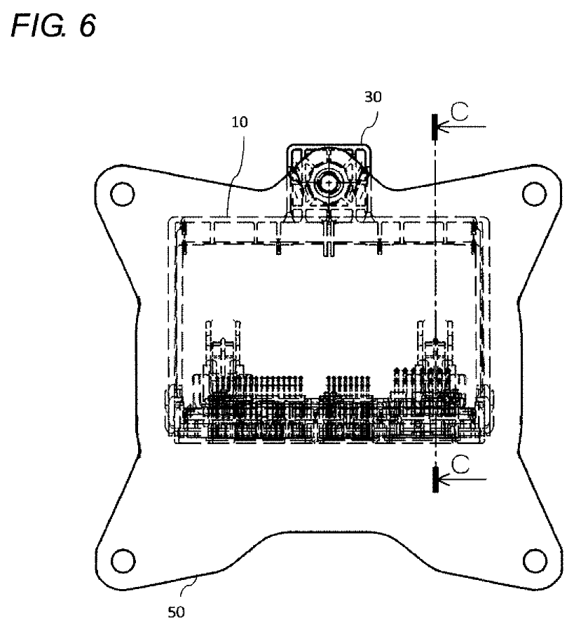

FIG. 7B illustrates the process of mounting the casing 10 on the vehicle body mounting member 50. Note that FIGS. 7A and 7B are cross-sectional views taken along line C-C in FIG. 6. The abutting and held portion 22 at the lower portion of the held member 20 of the casing 10 is inserted in the insertion recessed portion 63 of the holding member 60. When the connecting portion 24 abuts against the support 65, the holding member 60 temporarily holds the casing 10 via the held member 20. At this stage, since the held member 20 is fitted with play in the insertion recessed portion 63, the casing 10 is held in a state of being inclined to the right according to the center-of-gravity position of the casing 10. Alternatively, in a case where the play is small, the abutting portion 21 abuts against and presses the mounting surface 51, and the casing 10 is held in a state of being inclined to the right. A mounted portion 52 having a hole is provided at an upper portion of the vehicle body mounting member 50, that is, an upper portion of the mounting surface 51. A mounting portion 30 having a hole matching the hole of the mounted portion 52 is provided at an upper portion of the casing 10. There is a distance (gap) between the mounted portion 52 and the mounting portion 30.

In this state, when the casing 10 is pushed toward the mounting surface 51, the mounting portion 30 draws an arc shape with the abutting point between the support 65 and the connecting portion 24 as the center, as indicated by an alternate long and short dash line arrow and approaches the mounted portion 52. Finally, the mounting portion 30 abuts against the mounted portion 52. In this abutted state, both the mounting portion 30 and the mounted portion 52 are fixed by bolting or the like. At the stage where both the mounting portion 30 and the mounted portion 52 are fixed in this manner, as illustrated in FIG. 7A, the abutting portion 21 presses the mounting surface 51 as indicated by dotted arrow D1, the abutting and held portion 22 presses the holding member 60 as indicated by dotted arrow D2, and the mounting portion 30 pulls the mounted portion 52 as indicated by dotted arrow D3. Note that D1 indicates the direction in which the abutting portion 21 presses the mounting surface 51, D2 indicates the direction in which the abutting and held portion 22 presses the inner portion 62 of the holding member 60, and D3 indicates the direction in which the mounting portion 30 pulls the mounted portion 52.

In a case where the casing 10 is fixed to the mounting surface 51 in this manner, the casing 10 is mounted in a state where the abutting portion 21 of the held member 20 presses the mounting surface 51 due to the elastic force of the elastic body EB. In the mounting structure 100 in which the casing 10 is mounted as described above, the held member 20 is mounted in a state of pressing the mounting surface 51 due to the elastic force of the elastic body EB. Therefore, it is possible to suppress rattling and flapping due to vibration and impact. In the case of mounting the casing 10 housing an electronic circuit therein on the vehicle body C, a fitting method with a bolt is generally used. However, if this mounting structure 100 is used, it is possible to simplify the structure on the side of the vehicle body C on which the casing 10 is mounted as much as possible, to reduce the number of installation man-hours, and to make the installation space small.

In addition, the extended portion 23 between the abutting portion 21 and the abutting and held portion 22 has elasticity, the abutting portion 21 presses the mounting surface 51, and the abutting and held portion 22 presses the holding member 60 in the direction opposite to the direction in which the abutting portion 21 presses the mounting surface 51. Therefore, in the mounting structure 100, it is possible to suppress rattling and flapping due to vibration and impact and to simplify the structure on the side of the vehicle body C on which the casing 10 is mounted as much as possible.

In addition, the location at which the abutting portion 21 presses the mounting surface 51 is positioned in the middle between the location at which the mounting portion 30 and the mounted portion 52 are fixed and the location at which the abutting and held portion 22 presses the holding member 60. Since the mounting portion 30 and the mounted portion 52 allow the casing 10 to be fixed in a well-balanced manner as described above, it is possible to suppress rattling and flapping due to vibration and impact. In addition, it is possible to simplify the structure on the side of the vehicle body C on which the casing 10 is mounted as much as possible and to reduce the mounting man-hours.

In addition, it is preferable that the connecting portion 24 has a drain hole 25 preventing liquid stagnation (see FIGS. 2A, 2B, 5B, and 7A). In addition, it is preferable that the holding member 60 has a drain hole 61 preventing liquid stagnation (see FIGS. 3D, 5D, and 7A). As described, it is possible to prevent the material of the casing 10 from being hydrolyzed by providing the drain holes in portions where liquid easily accumulates.

In addition, it is preferable that the held member 20 further includes guard portions 26 disposed on both sides of the abutting portion 21 and configured to protect the abutting portion 21. As described above, by providing the guard portions 26 configured to protect the abutting portion 21 projecting from the casing 10, it is possible to prevent the extended portion 23 from being destroyed due to handling or the like at the time of mounting.

Note that the present invention is not limited to the embodiment described as an example, and can be implemented in a configuration within the scope not departing from the contents described in the respective claims. While the present invention has been particularly illustrated and described mainly with reference to a particular embodiment, those skilled in the art can make various changes in quantity and another detailed configuration to the above embodiment without departing from the technical ideas and the scope of the present invention.

1. A mounting structure for mounting a casing that houses an electronic component on a vehicle body, the mounting structure comprising:
a holding member provided on a mounting surface on a side of the vehicle body; and
a held member provided on the casing, at least partially configured of an elastic body, and configured to be held by the holding member,
the held member being configured to be mounted in a state of pressing the mounting surface due to elastic force of the elastic body.

2. The mounting structure according to claim 1,
wherein the held member includes:
an abutting portion configured to abut against the mounting surface in a case where the held member is mounted;
an abutting and held portion configured to abut against the holding member in a case where the held member is mounted;
an extended portion extending between the abutting portion and the abutting and held portion and at least partially made of an elastic body; and
a connecting portion connecting the abutting and held portion and the casing, and
wherein, in a case where the held member is mounted, the abutting portion presses the mounting surface and the abutting and held portion presses the holding member in a direction opposite to a direction in which the abutting portion presses the mounting surface.

3. The mounting structure according to claim 2, wherein each of the connecting portion and the holding member has a drain hole preventing liquid stagnation.

4. The mounting structure according to claim 2, wherein the held member further includes guard portions disposed on both sides of the abutting portion and configured to protect the abutting portion.

5. The mounting structure according to claim 2,
wherein the mounting surface includes a mounted portion,
wherein the casing includes a mounting portion matching the mounted portion,
wherein in a case where the mounting portion is mounted, the mounting portion is fixed to the mounted portion, and
wherein a location where the abutting portion presses the mounting surface is in a middle between a location where the mounting portion and the mounted portion are fixed and a location where the abutting and held portion presses the holding member.
